(19) United States
(12) Patent Application Publication
(10) Pub. No.: US 2011/0247509 A1
(43) Pub. Date: Oct. 13, 2011

(54) ID CARD PRINTER WITH MANUAL CARD SLOT

(75) Inventor: Byeong-Hyeon CHOI, Seoul (KR)

(73) Assignee: TIT ENG CO., LTD., Seoul (KR)

(21) Appl. No.: 12/901,474

(22) Filed: Oct. 8, 2010

(30) Foreign Application Priority Data
Apr. 8, 2010 (KR) 10-2010-32122

(51) Int. Cl. B41F 3/02

(52) U.S. Cl. 101/250

(57) ABSTRACT

An ID card printer with a manual card slot in which supplying of the cards to be printed into a printing unit is classified into an automatically supplying mode in which the cards to be printed are sequentially in an automatic way supplied from the conventional card hopper and a manually supplying mode in which the cards to be printed are manually supplied from a manual card slot one by one; the cards to be printed are selectively inserted into the printing unit based on the user's selections between the two modes depending on the priority of the printing event in question or current printing speed; and, the printed cards in the automatically supplying mode and the printed cards in the manually supplying mode are not mixed with each other but are collected back in a discrete manner, whereby improving efficiency of card printing operations.

### CROSS-REFERENCE TO RELATED APPLICATION

This application is based upon and claims priority from prior Korean patent Application No. 2010-0032122 filed on Apr. 8, 2010, the entire contents of which are incorporated herein by reference.

### BACKGROUND OF THE INVENTION

1. Field of the Invention

The present invention relates to a ID card printer, and, in particular, an ID card printer with a manual card slot in which a manual card slot is provided with an ID card printer printing ID information for identifying a person in question of a staff ID card, a membership card, a driver's license card, a credit card or the like together with an associated organization, and, thus, the cards to be printed are selectively inserted into a printing unit based on user's selections depending on the priority of the printing event in question or current printing speed, and, then, are printed and are collected back.

2. Description of Related Art

Generally, the ID card has thereon a certificated facial image and identification information of the person in question, and has been broadly used as a certificate of residence, a bank credit card, a health insurance card, a staff ID card of a certain company, an access control card, a student identity card, a teaching staff identity card, a membership card of a certain fitness club, a public service personnel card of a certain public organization of a government, a parking card, or the like.

Such a ID card is mainly manufactured as a stack type card in which the certificated facial image and/or the identification information of the person in question, etc are printed on a surface of a substrate made of plastic, and, then, a transparent lamina is deposited thereon in order to protect the printed data. Further, in case that the information protection and security is required, an identifying holographic image and/or magnetically recorded information are provided with the card.

A conventional ID card printer for printing various information onto the surface of such a ID card, as shown in FIG. 1, includes a card hopper 11 receiving, in a stacked way, a predetermined number of the cards to be printed; and card conveying rollers 12 disposed beneath the card hopper 11 to convey the card from the card hopper 11 to a card printing unit (not shown). Moreover, the card printer includes the card printing unit printing the various data onto the card, and a card stacker 14 collecting back and stacking the printed cards one after another.

In such a conventional ID card printer 10, as shown in FIG. 2a and FIG. 2b, to print one new card, the lowest card among the stacked cards within the card hopper 11 is conveyed by the conveying rollers 12, in an automatic way, toward a card guiding unit 13 and, then, into the card printing unit which, in turn, prints the various data or information on the card, and, then, the printed card is conveyed back toward the card guiding unit 13, and, then, is collected back and stacked sequentially into the card stacker 14.

The card guiding unit 13, when conveying the card to be printed into the card printing unit, is configured to have a first stage extending horizontally so that the conveyed card should be guided from the card hopper 11 to the card printing unit, while, the card guiding unit 13, when conveying the printed card into the card stacker 14, is configured to have a second stage slanting downwards from a lower position than the first stage so that the printed card should be guided from the card printing unit to the card stacker 14. In this way, the card to be printed and the printed card may pass through, respectively, the lower and upper spaces generated by the card guiding unit 13.

Herein, in the card printing unit, there is a separate card conveying device (not shown) which receives the conveyed card from the card hopper 11 so that it is printed, and, then, conveys the printed card into the card stacker 14.

In this conventional ID card printer 10, after one conveyed card from the card hopper 11 has been printed and the printed card has been conveyed and stacked into the card stacker 14, one new card placed at the lowest position of the card hopper 11 resulting from the collectively falling-down of the entire cards loaded in the card hopper 11 due to weights of the cards themselves is conveyed through the card conveying roller 12 into the card printing unit, and, then, the above-mentioned process may repeat.

However, in this conventional ID card printer 10, seeing that the loaded cards in the card hopper 11 are, always only in an automatic way, conveyed and supplied into the printing unit, in case that various kinds of the cards should be printed on a small quantity basis, it is required to replace the already loaded cards in the card hopper 11 with a new card(s) of the different kind to be printed, resulting in inconvenience.

To solve this problem, a manual card slot into which the card can be manually inserted one by one is, separately from the card hopper 11, provided with the conventional ID card printer so that the new card(s) of the different kind to be printed may be directly supplied through the manual card slot into the printing unit without replacing the already loaded cards in the card hopper 11 with the new card(s) of the different kind to be printed. However, although such a separate manual card slot is installed, in that when the cards are in the automatic way supplied from the card hopper 11 into the printing unit and the cards are in the manual way supplied from the manual card slot into the printing unit, the printed cards supplied from the card hopper 11 and the manual card slot finally have been always stacked in the same place as the card stacker 14 in a mixed state with each other, it is necessary, after all of the cards have been printed, to sort out the mixed printed and stacked cards and withdraw the sorted-out cards, thereby resulting in inconvenience as well.

### SUMMARY OF THE INVENTION

### Problems to be Solved

Accordingly, the invention is conceived with considerations of the above-mentioned situations, and, therefore, an object thereof is to provide an ID card printer with a manual card slot in which supplying of the cards to be printed into a printing unit is classified into an automatically supplying mode in which the cards to be printed are sequentially in an automatic way supplied from the conventional card hopper and a manually supplying mode in which the cards to be printed are manually supplied from a manual card slot one by one; the cards to be printed are selectively inserted into the printing unit based on the user's selections between the two modes depending on the priority of the printing event in question or current printing speed; and the printed cards in the automatically supplying mode and the printed cards in the manually supplying mode are not mixed with each other but are collected back in a discrete manner, whereby improving efficiency of card printing operations.

### Solution for Problems

To achieve the purpose, the invention provides an ID card printer comprising: a card hopper in which a plurality of cards to be printed are loaded; a manual card slot through which a card to be printed is manually inserted one by one; a card conveying unit conveying the cards loaded in the card hopper or the card inserted through the manual card slot; a printing unit printing various information data onto the conveyed card through the card conveying unit; a card stacker collecting back and stacking the printed card which is supplied from the card hopper and then is printed by the printing unit; and a card conveying channel selecting unit selecting between first and second card conveying channels, the first card conveying channel being formed between the card conveying unit and the printing unit and being a card conveying channel of the card supplied from the card hopper, and the second card conveying channel being formed between the manual card slot and the printing unit and being a card conveying channel of the card supplied from the manual card slot. When the card conveying cannel selecting unit selects the first card conveying channel, the second card conveying channel becomes closed and, at the same time, a card conveying channel from the printing unit to the card stacker becomes open so that the printed cards are collected back and stacked in the card stacker, whereas when the card conveying cannel selecting unit selects the second card conveying channel, the card conveying channel from the printing unit to the card stacker becomes closed, and, at the same time, the first card conveying channel becomes open, and, then, the printed card is discharged from the printing unit through the manual card slot.

Preferably, the card conveying unit includes an automatically conveying roller at a lower end of a printing unit side wall of the card hopper, and includes a manually conveying roller between the manual card slot and the card conveying cannel selecting unit. When the card is supplied from the card hopper, only the automatically conveying roller rotates so that the card loaded in the card hopper is conveyed to the printing unit, whereas when the card is supplied from the manual card slot, only the manually conveying roller rotates so that the card into the manual card slot is conveyed to the printing unit, and, then, the printed card by the printing unit is discharged from the printing unit through the manual card slot.

### Effects of the Invention

In accordance with the ID card printer with the manual card slot of the invention, seeing that in the automatically supplying mode, the printed cards are collected back and stacked in the card stacker, while, in the manually supplying mode, the printed card is directly discharged through the slot into which the card was inserted (the manual card slot), the cards are selectively inserted into the printing unit based on the user's selections between the two modes depending on the priority of the printing event in question or current printing speed, and, hence, the supplied cards in the two modes are distinguished from each other and, then, the printed cards in the two modes are not mixed with each other in collecting back the printed cards, so that it is easy and simple to collect back the printed cards, whereby improving efficiency of the card printing operations.

### BRIEF DESCRIPTION OF THE DRAWINGS

Other objects and advantages of the present invention will become apparent from the following description of exemplary embodiments with reference to the accompanying drawings in which:

FIG. 1 is a side view of a schematic configuration of the conventional ID card printer;

FIG. 2a to FIG. 2c are side views, in the ID card printer of FIG. 1, illustrating a process of supplying a card to be printed to a printing unit and collecting back a printed card by the printing unit;

FIG. 3a and FIG. 3b are perspective views of schematic configurations in the automatically and manually supplying modes respectively according to an exemplary embodiment of the invention;

FIG. 4a to FIG. 4c are side views, in a state of the ID card printer as shown in FIG. 3a, illustrating a process of supplying, in an automatic way, a card to be printed being loaded in a card hopper to a printing unit and collecting back a printed card by the printing unit; and

FIG. 5a to FIG. 5c are side views, in a state of the ID card printer as shown in FIG. 3b, illustrating a process of supplying, in a manual way, a card to be printed through a manual card slot to the printing unit and discharging back the printed card by the printing unit to the manual card slot.

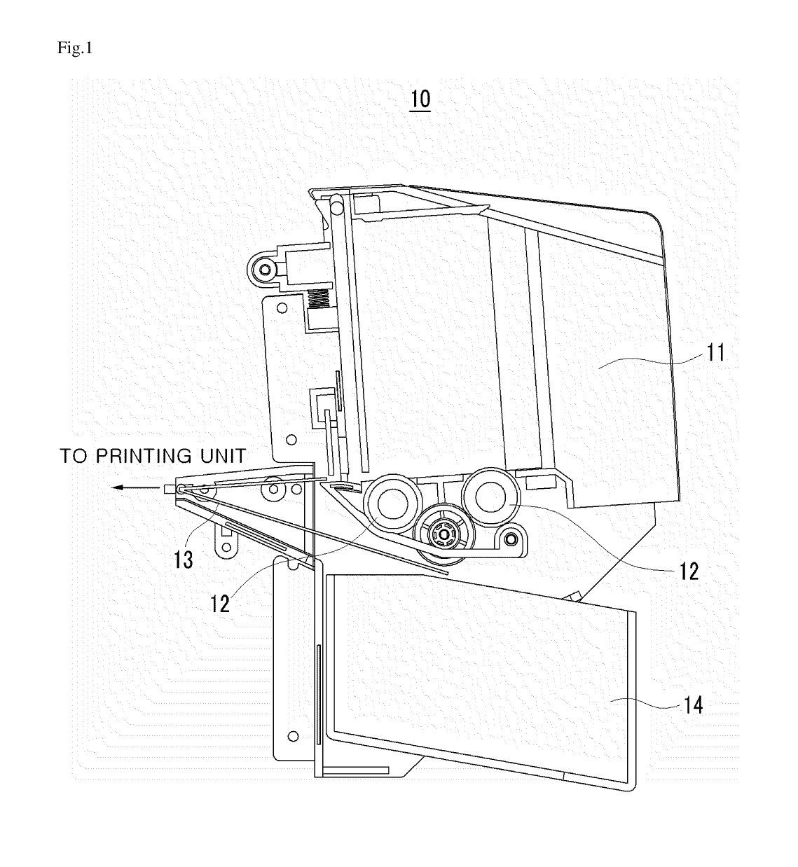

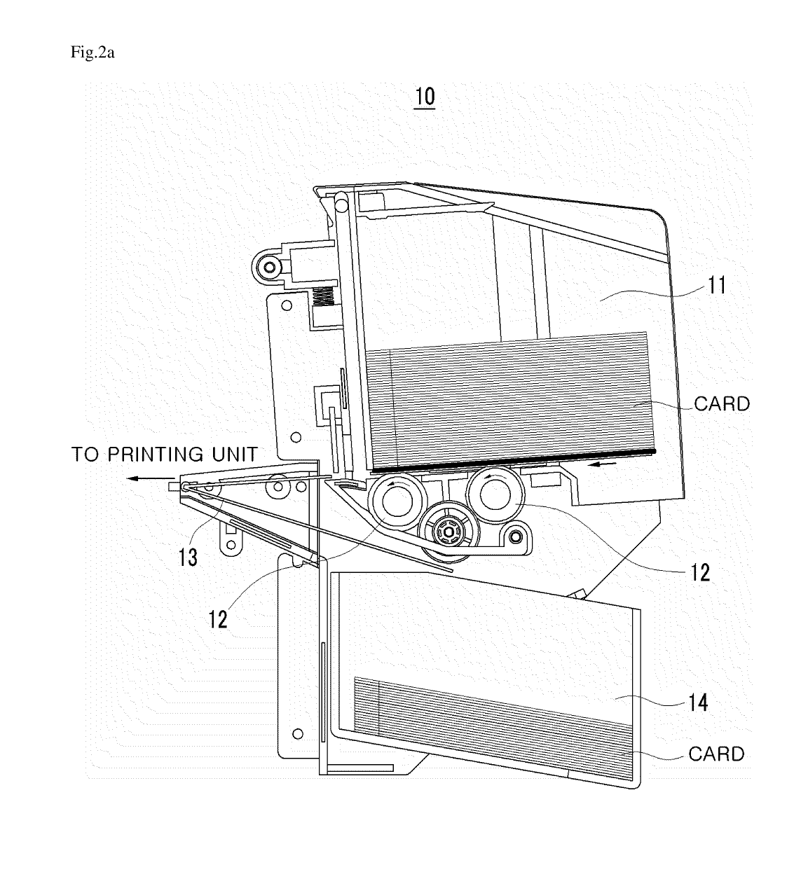

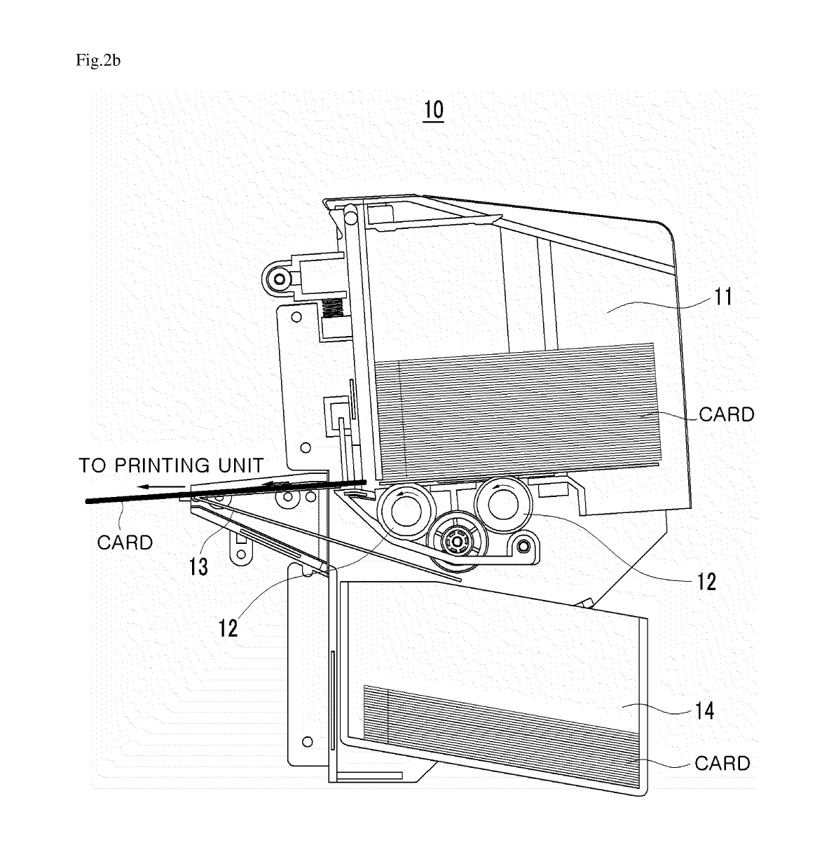

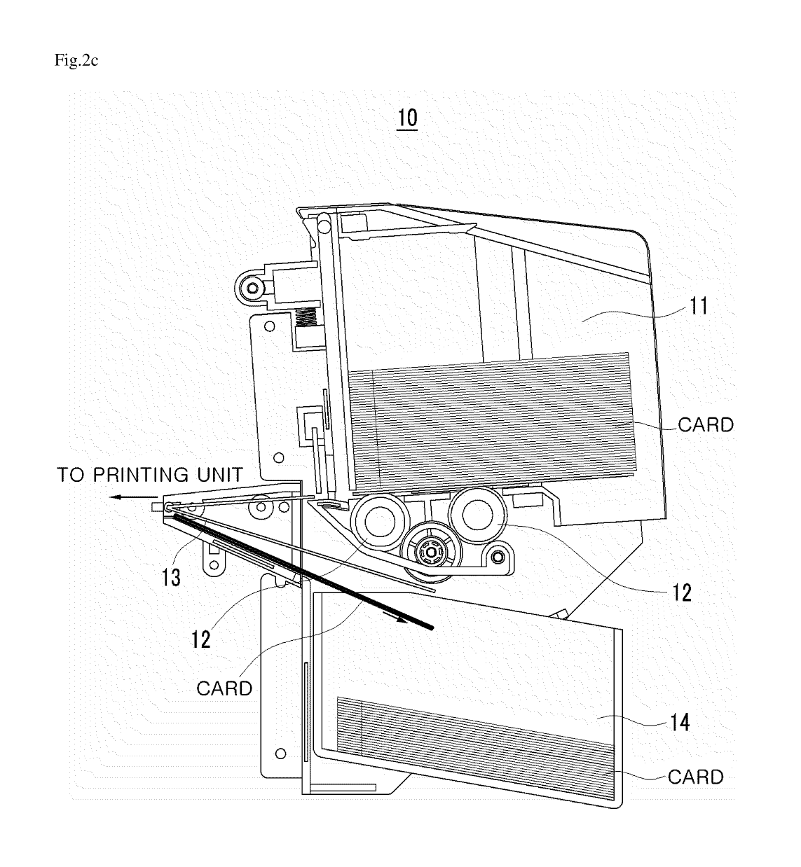

### DETAILED DESCRIPTION OF THE PREFERRED EXEMPLARY EMBODIMENTS

Exemplary embodiments of the present invention will be described with reference to the accompanying drawings. The embodiments are provided to explain the invention in details so that the skilled person in the art practices the invention without undue efforts, and, therefore, the embodiments should be construed not to limit the spirit and scope of the invention. In the drawings, the same reference numerals represent the same parts or components.

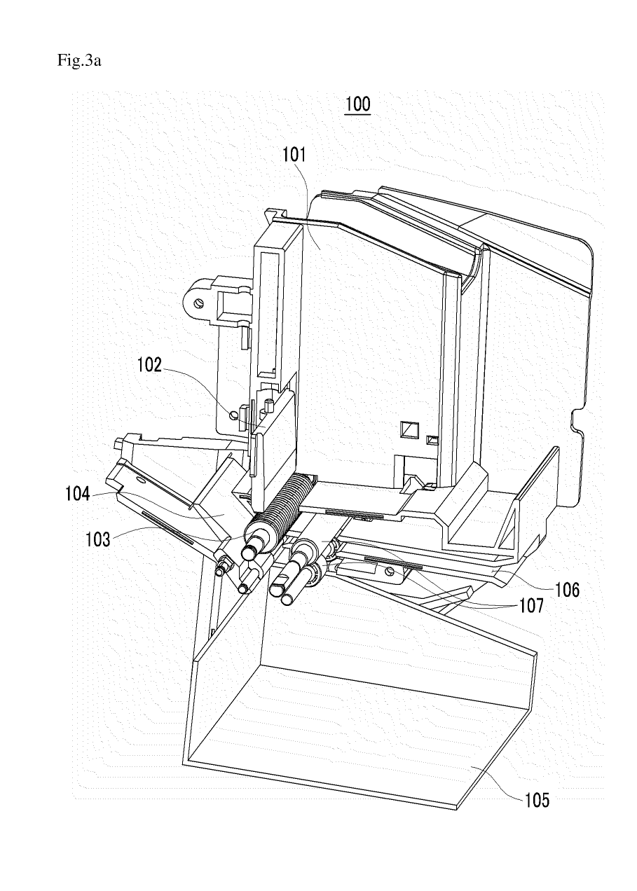

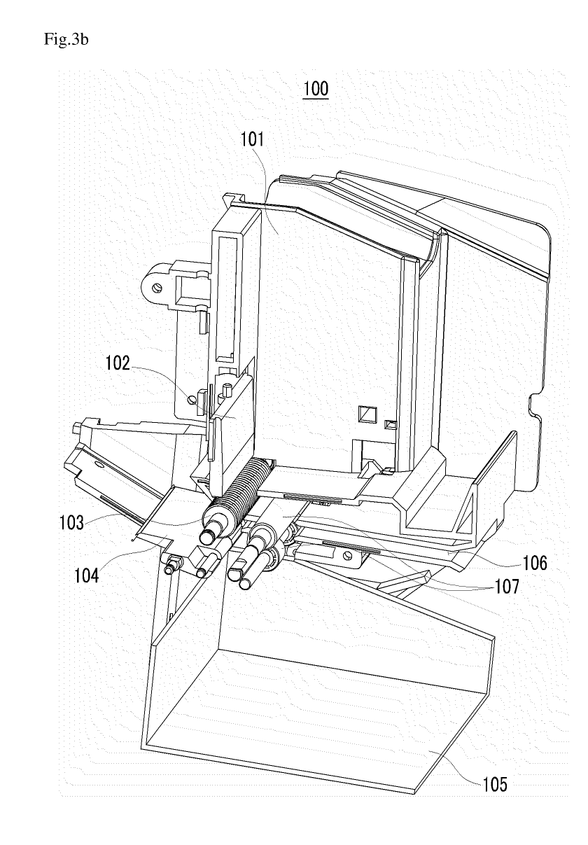

FIG. 3a and FIG. 3b are perspective views of schematic configurations in the automatically and manually supplying modes respectively according to an exemplary embodiment of the invention.

The ID card printer 100 according to the exemplary embodiment of the invention includes a card hopper, a manual card slot, a card conveying unit, a printing unit, a card stacker and a card conveying channel selecting unit.

The card hopper 101 is formed as a rectangular box shape in which a plurality of cards to be printed may be loaded, and at a bottom face thereof, an opening is formed which is in contact with the card conveying unit, and, further, between a lower end of a printing unit side wall thereof and a bottom face of the hopper, a frame gap 102 is formed through which the loaded cards are conveyed toward the printing unit.

The frame gap 102 is disposed above an automatically conveying roller 103 in such a way as to keep on being spaced, by a predetermined width (for example, slightly larger than a thickness of one card), with the roller 103, and, thus, prevents double cards from being supplied at one time, that is, has only a single conveyed card, when the automatically conveying roller 103 rotates in a counterclockwise direction, pass through between the roller 103 and the gap 102 due to surface friction between the card and the roller 103, but has two or double cards overlapped over each other not pass through between them.

The card conveying unit conveys to the printing unit the loaded cards in the card hopper 101 or the card inserted through the manual card slot 106. Herein, the automatically conveying roller 103 is installed at a lower end of a printing unit side wall of the card hopper 101, and a manually conveying roller 107 is installed between the manual card slot 106 and the card conveying cannel selecting unit.

Herein, the automatically conveying roller 103 is in contact with a tip end of the lowest card among the loaded cards in the card hopper 101, and, at the same time, conveys the cards to be printed from the card hopper 101 toward the frame gap 102 one by one. At this case, only the automatically conveying roller 103 rotates but the manually conveying roller 107 does not rotate.

The manually conveying roller 107 rotates only when the card is supplied from the manual card slot 106, and, in turn, conveys the card inserted through the manual card slot 106 to the printing unit, and, then, discharges back the printed card by the printing unit to the manual card slot 106.

The printing unit (not shown) includes a thermally printing unit in which the conveyed card through the card conveying unit is thermally printed, and, to be specific, a thermal head is included in the unit to thermally print the various information data onto the card.

The card stacker 105 is disposed under the bottom of the card hopper 101, and is formed as a rectangular box shape in which the card supplied from the card hopper 101 and printed by the printing unit is collected back and stacked therein.

The card conveying channel selecting unit selects the associated conveying channel with the supplied card, and, herein, selects between first and second card conveying channels, the first card conveying channel being formed between the card conveying unit and the printing unit and being a card conveying channel of the card supplied from the card hopper 101, while the second card conveying channel being formed between the manual card slot 106 and the printing unit and being a card conveying channel of the card supplied from the manual card slot 106.

In the exemplary embodiment, a frame shutter 104 is, rotatably in upward and downward directions, installed, and is configured to operate as the card conveying channel selecting unit so as to have opened only either one of the first card conveying channel (being the card conveying channel of the card supplied from the card hopper 101) or the second card conveying channel (being the card conveying channel of the card supplied from the manual card slot 106).

For example, if the card is supplied from the card hopper 101, the frame shutter 104 selects the first card conveying channel being the card conveying channel of the card supplied from the card hopper 101, and, thus, the frame shutter 104 has rotated in the upward direction as shown in FIG. 3a, so that the second card conveying channel being the card conveying channel of the card supplied from the manual card slot 106 becomes closed and, at the same time, a card conveying channel from the printing unit to the card stacker 105 becomes open, and, hence, the printed cards are collected back and stacked in the card stacker 105.

On the other hand, if the card is supplied from the manual card slot 106, the frame shutter 104 selects the second card conveying channel being the card conveying channel of the card supplied from the manual card slot 106, and, thus, the frame shutter 104 has rotated in the downward direction as shown in FIG. 3b, so that the card conveying channel from the printing unit to the card stacker 105 becomes closed and, at the same time, a card conveying channel from the manual card slot 106 to the printing unit becomes open, and, hence, the printed card is discharged back from the printing unit to the manual card slot 106.

The frame shutter 104 is controlled so as to rotate in the upward and downward directions around a rotational axis, and, specifically, the frame shutter 104 has rotated in the upward direction as shown in FIG. 3a so as to close the card conveying channel of the card supplied from the manual card slot 106, and, at the same time, to have the printing operation of the card supplied from the card hopper 101 activated, whereas the frame shutter 104 has rotated in the downward direction as shown in FIG. 3b so as to close the card conveying channel from the printing unit to the card stacker 105, and, at the same time, to have the printing operation of the card supplied from the manual card slot 106 activated.

For the sake of such control, a sensor (not shown) for sensing whether the card is being inserted or not may be installed between the manual card slot 106 and the manually conveying roller 107, and, thus, when the sensor detects that the card is being inserted, the sensor instructs the frame shutter 104 to be rotated in the downward direction as shown in FIG. 3b. Otherwise, the tip end of the card supplied from the slot 106 which is being conveyed with the manually conveying roller 107 may directly push, in a compulsory way, against the frame shutter 104 so as to rotate downwards.

The manual card slot 106 is configured so that, in a separate mode from the mode in which the cards to be printed are sequentially in an automatic way supplied from the card hopper 101, the cards to be printed are manually inserted therein one by one and, then, is supplied to the printing unit one by one. Accordingly, while the supplied cards in the two modes (automatic and manual modes) are distinguished from each other, the supplying of the cards to be printed and the collecting-back of the printed cards may be performed.

Now, operations of the ID card printer 100 according to the exemplary embodiment of the invention will be described in details with reference to the drawings.

First, in case that the cards to be printed are continuously in the automatic way supplied from the card hopper 101 included in the ID card printer 100 according to the exemplary embodiment of the invention, the frame shutter 104 has rotated in the upward direction so that the state as shown in FIG. 3a is kept.

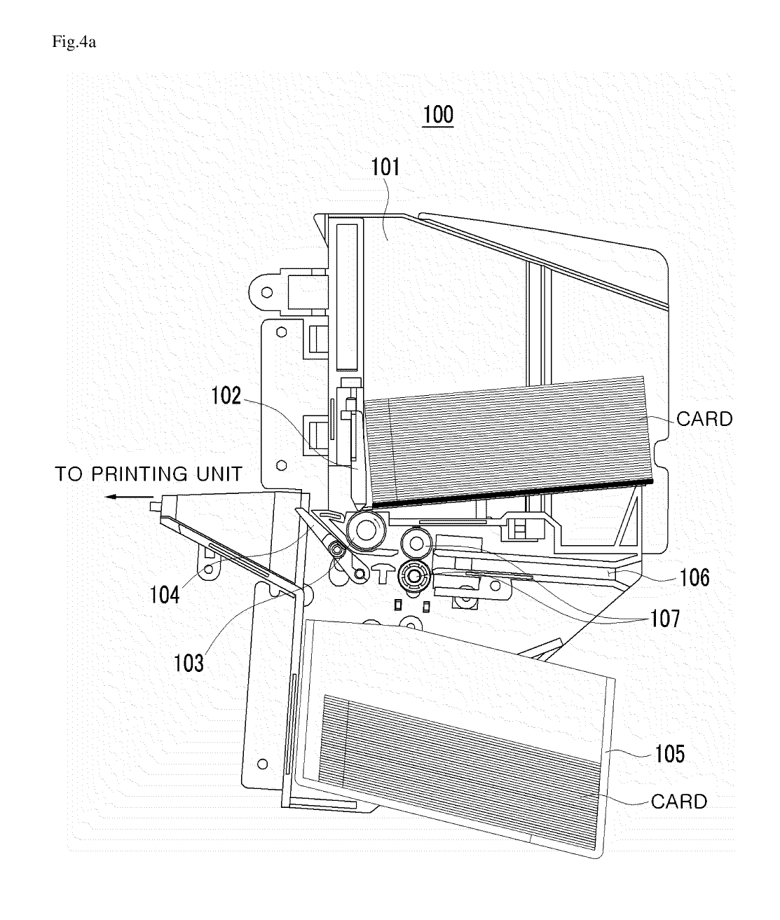

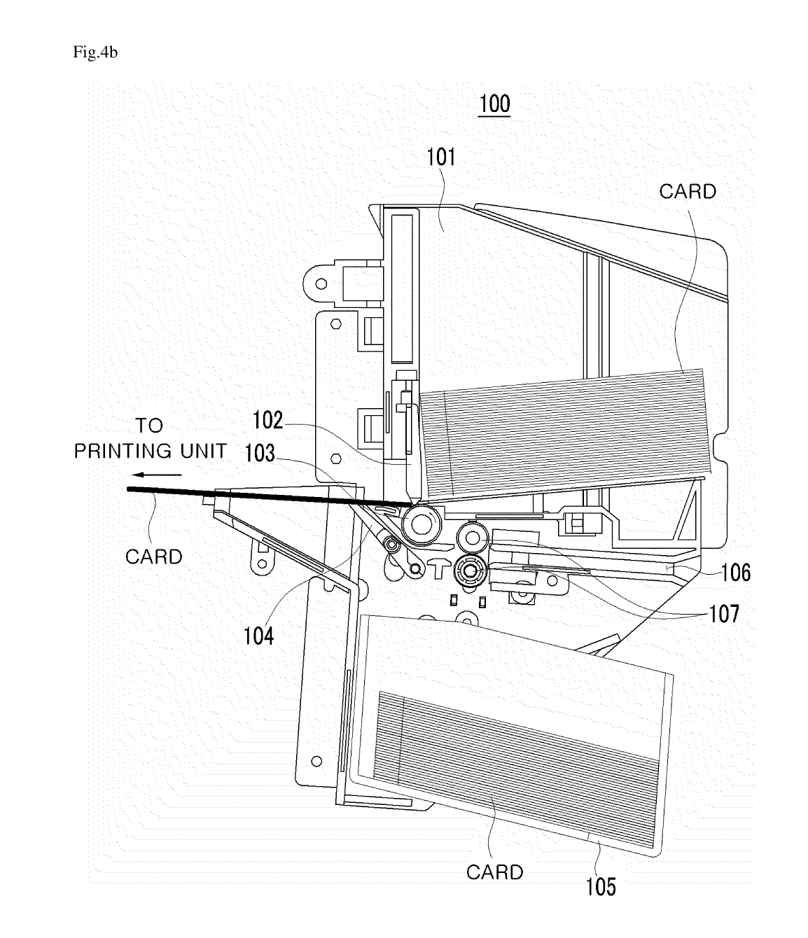

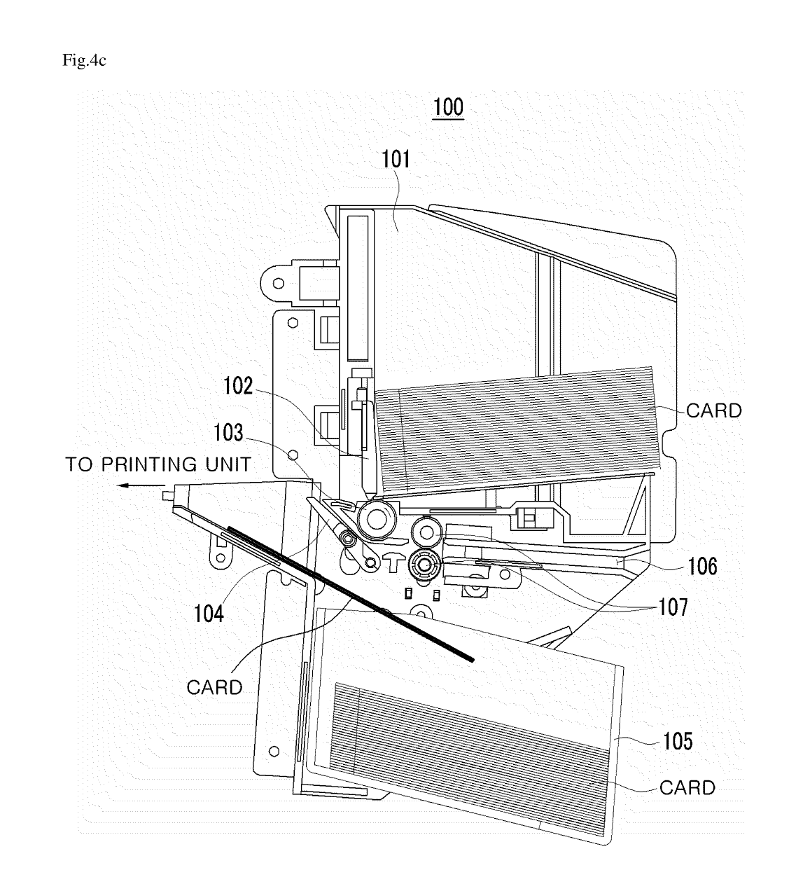

FIG. 4a to FIG. 4c are side views, in the state of the ID card printer as shown in FIG. 3a, illustrating the process of supplying, in the automatic way, the cards to be printed being loaded in the card hopper 101 to the printing unit and collecting back the printed cards by the printing unit.

The frame shutter 104 selects, as shown in FIG. 4a to FIG. 4c, the first card conveying channel being the card conveying channel of the card supplied from the card hopper 101, and, thus, closes the second card conveying channel being the card conveying channel of the card supplied from the manual card slot 106, and, at the same time, opens the card conveying channel from the printing unit to the card stacker 105. In this state, the automatically conveying roller 103 rotates together with the rotation of a cam coupled to a motor (not shown), and, in turn, the lowest loaded card in the card hopper 101, while supported with the roller 103, passes through the frame gap 102 toward the printing unit, and, then, the printed card in the printing unit is conveyed along the open card conveying channel and then is received and stacked in the card stacker 105.

Second, in case that the cards to be printed are, in the manual way, supplied one by one from the manual card slot 106 included in the ID card printer 100 according to the exemplary embodiment of the invention, the frame shutter 104 has rotated in the downward direction so that the state as shown in FIG. 3b is kept.

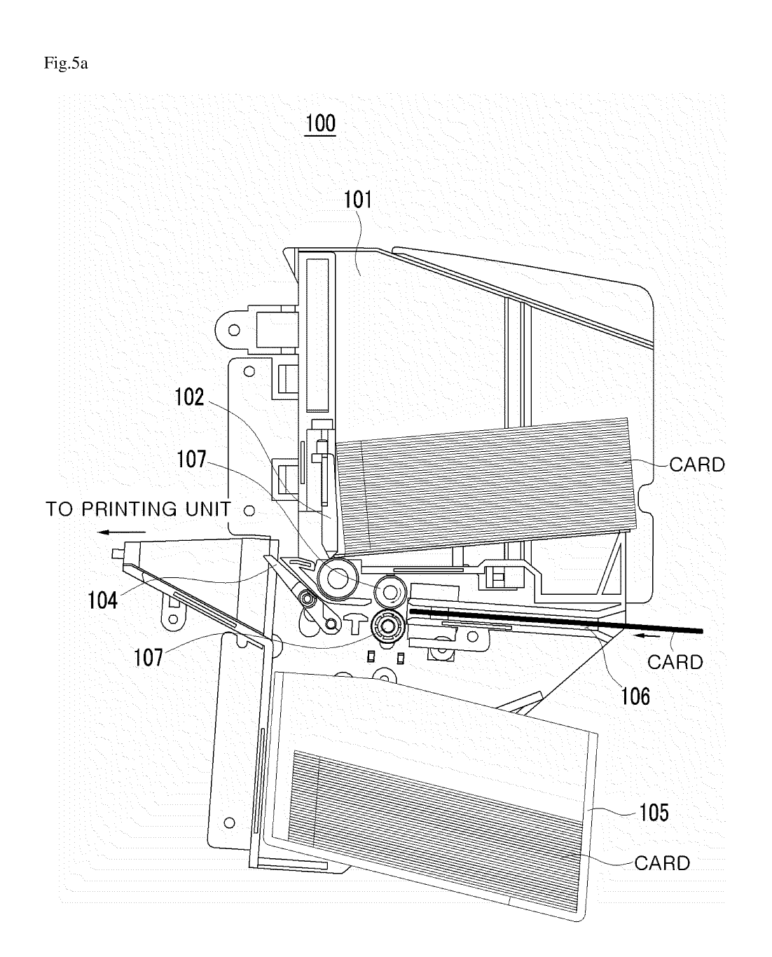

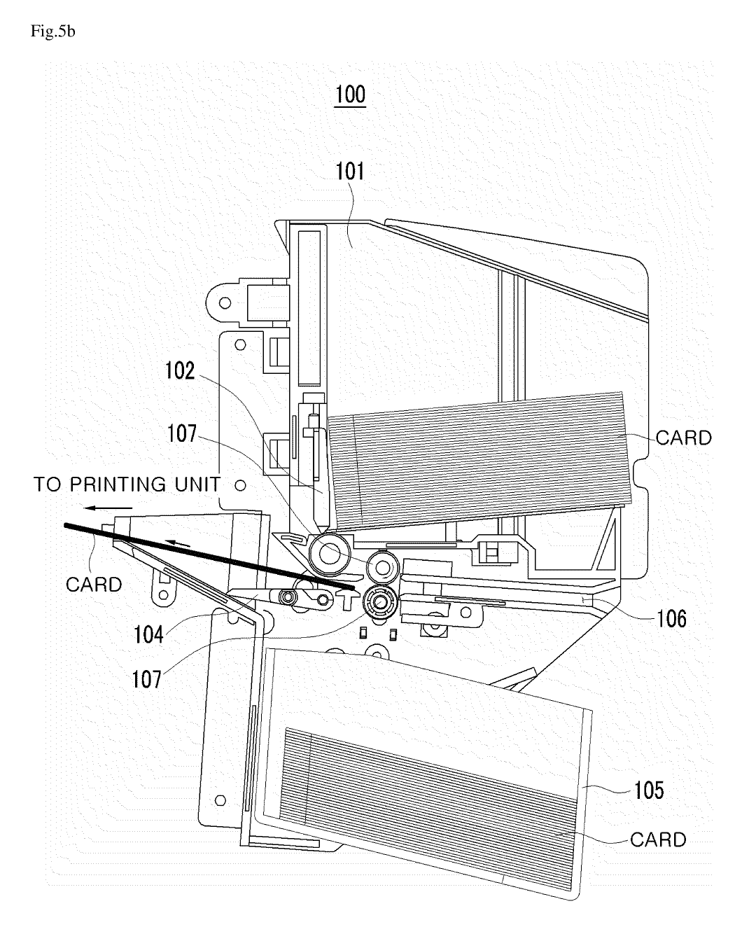

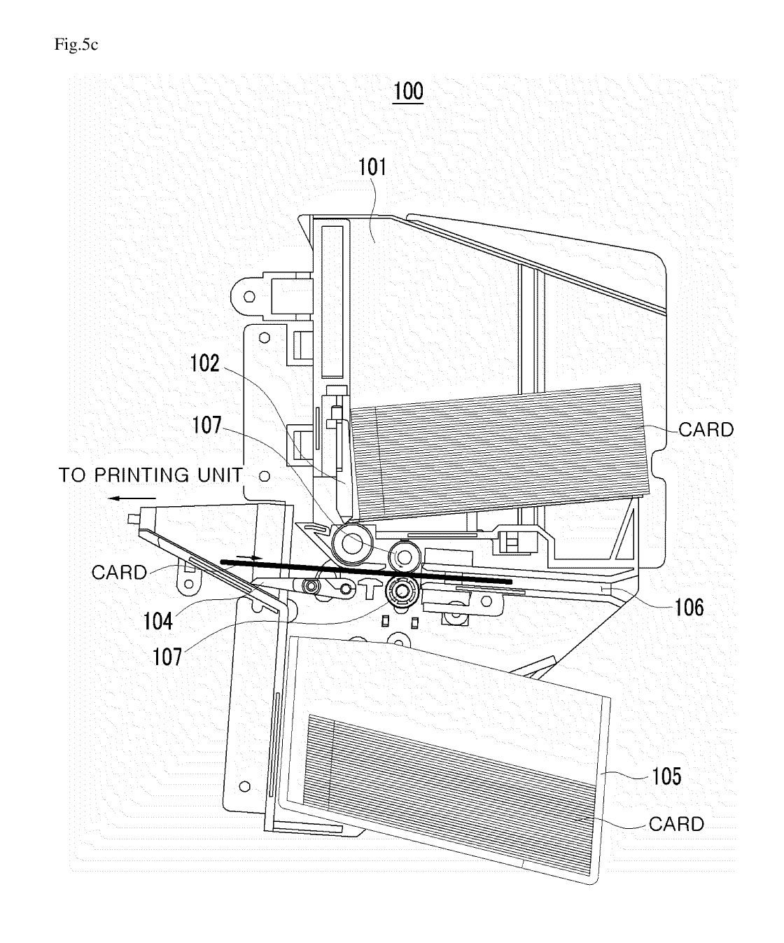

FIG. 5a to FIG. 5c are side views, in the state of the ID card printer as shown in FIG. 3b, illustrating the process of supplying, in the manual way, the cards to be printed through the manual card slot 106 to the printing unit and discharging back the printed card by the printing unit to the manual card slot 106.

The frame shutter 104 selects, as shown in FIG. 5a to FIG. 5c, the second card conveying channel being the card conveying channel of the card supplied from the manual card slot 106, and, thus, closes the card conveying channel from the printing unit to the card stacker 105, and, at the same time, opens the second card conveying channel from the manual card slot 106 to the printing unit, so that after the supplied card from the manual card slot 106 has been printed in the printing unit, the printed card is discharged back to the manual card slot 106.

Herein, to control the frame shutter 104 so as to rotate in the downward direction, the sensor (not shown) for sensing whether the card is being inserted through the manual card slot 106 or not detects that the card is being inserted through the slot 106, and, in turn, based on such detection, the sensor instructs the frame shutter 104 to be rotated in the downward direction as shown in FIG. 3b. Otherwise, the tip end of the card which is being conveyed with the manually conveying roller 107 may directly push, in a compulsory way, against the frame shutter 104 so as to rotate downwards.

Further, the frame shutter 104 keeps on being in the state in which it lies down, and, hence, the printed cards are discharged back to the slot 106 along the same channel along which the cards were supplied from the slot 106.

In this way, if there occur urgent card printing events (such as printings of MS card, RF card or IC card), it is possible to deal with such urgent events rapidly. In particular, in that after the card supplied through the manual card slot 106 has been printed, the printed card is discharged back not into the card stacker 105 but to the manual card slot 106, the problem is eliminated that the printed cards are collected back or stacked in the stacker 105 in a mixed state with each other, thereby improving the efficiency of the card printing operation.

The invention is not limited to the exemplary embodiment, but, rather, many variations are possible without departing from the scope of accompanying claim(s).

### LIST OF COMPONENTS

10: conventional ID card printer
11, 101: card hopper
12: card conveying roller
13: card guiding unit
14, 105: card stacker
100: ID card printer according to one exemplary embodiment of the invention
102: frame gap
103: automatically conveying roller
104: frame shutter
106: manual card slot
107: manually conveying roller

What is claimed is:

1. An ID card printer comprising:
a card hopper in which a plurality of cards to be printed are loaded;
a manual card slot through which a card to be printed is manually inserted one by one;
a card conveying unit conveying the cards loaded in the card hopper or the card inserted through the manual card slot;
a printing unit printing various information data onto the conveyed card through the card conveying unit;
a card stacker collecting back and stacking the printed card which is supplied from the card hopper and then is printed by the printing unit; and
a card conveying channel selecting unit selecting between first and second card conveying channels, the first card conveying channel being formed between the card conveying unit and the printing unit and being a card conveying channel of the card supplied from the card hopper, and the second card conveying channel being formed between the manual card slot and the printing unit and being a card conveying channel of the card supplied from the manual card slot,
wherein when the card conveying cannel selecting unit selects the first card conveying channel, the second card conveying channel becomes closed and, at the same time, a card conveying channel from the printing unit to the card stacker becomes open so that the printed cards are collected back and stacked in the card stacker, whereas when the card conveying cannel selecting unit selects the second card conveying channel, the card conveying channel from the printing unit to the card stacker becomes closed, and, at the same time, the first card conveying channel becomes open, and, then, the printed card is discharged back from the printing unit to the manual card slot.

2. The ID card printer of claim 1, wherein the card conveying unit includes an automatically conveying roller at a lower end of a printing unit side wall of the card hopper, and includes a manually conveying roller between the manual card slot and the card conveying cannel selecting unit; and
wherein when the card is supplied from the card hopper, only the automatically conveying roller rotates so that the card loaded in the card hopper is conveyed to the printing unit, whereas when the card is supplied from the manual card slot, only the manually conveying roller rotates so that the card into the manual card slot is conveyed to the printing unit, and, then, the printed card by the printing unit is discharged back from the printing unit to the manual card slot.
